(19) United States
(12) Patent Application Publication
(10) Pub. No.: US 2006/0293416 A1
(43) Pub. Date: Dec. 28, 2006

(54) Polyester masterbatch composition

(76) Inventors: Gary Peeters, Victoria (AU); Michael Shane O'Shea, Victoria (AU); Graeme Moad, Victoria (AU); Ramon Dean Tozer, Victoria (AU); Dirk Simon, Lorrach-Brombach (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/557,228

(22) PCT Filed: May 10, 2004
(86) PCT No.: PCT/EP04/50744

§ 371 Date: Nov. 17, 2005

(30) Foreign Application Priority Data
May 19, 2003 (AU) 2003902430
May 19, 2003 (AU) 2003902431

(51) Int. Cl. C08J 3/22; C08K 5/53

(52) U.S. Cl. 523/351; 524/132

(57) ABSTRACT

The present invention relates to masterbatches useful for modifying thermoplastic polyesters, in particular to masterbatches comprising dispersed polyol branching agent and/or chain coupling agents, such as for example dianhydrides. The invention also relates to a method for preparing the masterbatches, and to a method for modifying a polyester utilizing the masterbatches. Yet another aspect of the invention is the use of such a masterbatch composition for the modification of polyesters.

The present invention relates to masterbatches useful for modifying thermoplastic polyesters, in particular to masterbatches comprising dispersed polyol branching agents and/or chain coupling agents. The invention also relates to a method for preparing the masterbatches, and to a method for modifying a polyester utilizing the masterbatches.

Thermoplastic polyesters such as poly(ethylene terephthalate) (PET) and poly(butylene terephthalate) (PBT) are widely used in the fields of extrusion, injection molding and stretch blow molding to produce products such as fibers, containers and films.

While polyesters may be used in other fields such as film blowing, tentering, thermnoforming and foam extrusion, their use in these fields is often limited by the need for a narrow processing window and spezialised processing equipment. Such limitations generally stem from deficiencies in the melt rheology of the polyesters. In particular, polyesters typically have low melt viscosity, low melt strength and low melt elasticity.

It is known that the melt strength and melt viscosity of polyesters can be improved through the introduction of a degree of branching in the linear chain structure of the polymer, and/or by increasing the polymers molecular weight through chain extension. One approach used to prepare branched or chain extended polyesters has involved melt mixing polyesters with branching and/or chain coupling agents such as polyfunctional carboxylic acids, anhydrides or alcohols. During melt mixing, the agents react with the molten polyester to chain extend and/or introduce branching in the linear chain structure of the polymer.

Depending upon the type of branchingichain coupling agent(s) used to modify the polyester, the overall effect of the melt mixing reaction may in fact decrease the molecular weight of the polyester. This will often be the case where the only type of agent used is a polyol branching agent. Under these circumstances, in order to achieve the desired increase in melt strength and melt viscosity, a chain coupling agent can be used in combination with the polyol, or the resulting branched polyester can be subjected to a further processing step such as a solid state condensation process. In contrast, polyanhydride branching/chain coupling agents can introduce branching, but also generally cause an increase in the molecular weight of the polymer during melt mixing. Accordingly, polyanhydride branching/chain coupling agents can be used as a sole branching/chain coupling agent without subjecting the modified polyester to further processing.

Regardless of the type of branching/chain coupling agent used, to effectively modify the polyester it is important that the degree of branching/chain coupling can be controlled during the melt mixing process, and that branching/chain coupling occurs uniformly in the polyester.

Generally melt mixing is performed in an extruder, and the branching/chain coupling agent can be added to the polyester either before extrusion, or to the molten polyester during extrusion. The most simplistic way in which the agent can be added to the polyester is by direct addition. However, this mode of addition has been found to lead to gel formation through excessive localized chain coupling, and non-uniform branching within the modified polyester. This also leads to detrimental discoloration. Furthermore, it is not uncommon to use amounts of less than 0.5 weight percent of the branching/chain coupling agent, relative to the polyester to be modified. At these low levels, it is difficult to provide a uniform distribution of the agent in the polyester by direct addition.

Many of the aforementioned problems associated with the addition of branching/chain coupling agents can be overcome through use of a polymer blend, concentrate, or masterbatch as it is commonly referred to in the art The masterbatch comprises high levels of the branching/chain coupling agent, but when added to the polyester it in effect acts as a diluted source of the agent. This diluent effect enables the branching/chain coupling agent to be distributed more evenly throughout the polyester and promotes a more uniformly branched/chain extended polyester.

In its simplest form, the masterbatch may be a physical blend of a carrier polymer and the branching/chain coupling agent, with both the agent and the carrier polymer often being in a powdered form. To avoid problems associated with incompatibility, the carrier polymer is preferably the same as, or of the same general class as, the base polymer to which the masterbatch is to be melt mixed with. For example, if the base polymer is a polyester, the carrier polymer is preferably also a polyester. Although effective, such physical blends do have a tendency to separate out into the individual components and again give rise to non-uniform distribution of the branching/chain coupling agent.

A masterbatch can also be readily formed by melt mixing a carrier polymer with the branching/chain coupling agent. However, when the carrier polyester this may lead to problems. In particular, given that the branching/chain coupling agents react with a polyester during melt mixing, the same or similar carrier polyester will also generally react with the agents during preparation of the masterbatch.

As a means of circumventing this problem, U.S. Pat. No. 5,801,206 discloses a masterbatch comprising branching agents where the carrier polymer is an inert polyolefin. Preparation of a masterbatch of this type by melt processing does therefore not result in the reaction of the branching agents with the carrier polymer. Although these masterbatches provide a means to add the agents to a polyester, the resulting modified polyester will inherently always be contaminated with polyolefin. This contamination may be tolerable, and possibly desired, in some instances, however it can also be detrimental and—depending on the actual addition level—might lead to hazy end products. For example, the quality of foamed polyester can be reduced by the presence of polyolefin contamination.

U.S. Pat. No. 5,536,793 discloses a masterbatch comprising branching agents where the carrier polymer is a polyester such as PET. In this case, the reactivity of the branching agent toward the carrier polymer during melt processing is used advantageously. In particular, by ensuring sufficient branching agent is present during melt mixing, the end groups of the polyester chains are in effect capped by the branching agent, which in turn is believed to prevent further reaction of the branching agent with the polyester. By using higher amounts of branching agent than is required to cap all of the polyester chains, a masterbatch comprising unreacted branching agent can be prepared.

However, masterbatches disclosed in U.S. Pat. No. 5,536,793 are limited in terms of composition. Sufficient branching agent to cap the end groups of the polyester carrier must initially be present during melt mixing to prevent crosslinking and gel formation. In practice, this typically limits the masterbatch composition to comprising no less than 5 weight percent of the branching agent. Furthermore, the capping reaction disclosed is based on the reaction of the polyester end groups with a polyfunctional anhydride branching agent. A similar reaction using other agents such as a polyfunctional alcohol branching agent is unlikely to prevent reaction of the polyol with the carrier polyester during melt blending. In particular, polyol compounds are known to readily react with internal ester groups of a PET chain during a melt blending process (transesterification). Under these circumstances, most, if not all, of the polyol branching agent would react with the polyester carrier to thereby render the material unsuitable for use as a masterbatch. Accordingly, the composition of the masterbatch disclosed in U.S. Pat. No. 5,536,793 is further limited to the use of a polyfunctional anhydride branching agents.

It would therefore be desirable to provide a masterbatch that comprised a polyester as a carrier material and a branching and/or a coupling agent, wherein the composition of the masterbatch was less restricted in terms of the amount and type of the branching and/or coupling agent incorporated.

Surprisingly, it has been found that polyesters having a melt processing temperature of 250° C. or less can be melt mixed with branching and/or chain coupling agents without significant reaction occurring between the branching and/or chain coupling agent and the polyester. Under these circumstances, a polyester can be melt mixed with a wide array of branching and/or chain coupling agents at both high and low concentrations to prepare masterbatches useful for subsequent melt mixing with other thermoplastic polyesters. Advantageously, agents such as polyfunctional acid anhydrides and polyols can be combined together within the masterbatch of the present invention.

One aspect of the present invention is a polyester masterbatch composition comprising a branching and/or a chain coupling agent dispersed within a polymeric matrix of polyester, wherein the polyester has a melt processing temperature of 250° C. or less.

As used herein, the term “masterbatch” has the common meaning as would be understood by one skilled in the art. With particular reference to the present invention, a masterbatch is a composition comprising a polyester as a carrier polymer and an agent, such as a branching and/or a chain coupling agent, where the concentration of the agent is higher than desired in a final product, and which composition is subsequently let down in a base polymer to produce the final product having the desired amount of agent.

As used herein, the term “melting temperature” of a branching or chain coupling agent is used to denote a temperature at which the agent begins to melt.

As used herein, the term “melt processing temperature” of a polyester is used to denote the lowest temperature that the polyester can be maintained at to enable it to be effectively melt processed.

As used herein, the term “branching agent” or “branching compound” is used to denote a polylunctional compound which can react with a polyester to introduce branching therein. It will be appreciated that in order to introduce branching, the branching agent will necessarily have at least three functional groups that are capable of reacting with the polyester.

As used herein, the phrase “a branching and/or a chain coupling agent” is used to mean at least one chain branching agent or chain coupling agent. It embraces both types of agent and multiple agents in combination.

The branching and/or chain coupling agent in accordance with the masterbatch of the present invention is dispersed within a polymeric matrix of polyester. By “dispersed” is meant that the agent is present as a separate largely unreacted entity within the polymeric matrix, and has therefore not reacted with the polymeric matrix to become an integral part thereof.

In one embodiment of the present invention, the agent(s) selected for the polyester masterbatch is preferably a branching agent, and the branching agent is preferably a polyol.

In another embodiment of the present invention, the agent(s) selected for the polyester masterbatch is preferably a coupling agent, and the coupling agent is preferably a dianhydride. It will be appreciated by those skilled in the art that a dianhydride can also function as a branching agent. For convenience, an agent which can function as both a branching and a coupling agent may herein also be referred to as a “branching/coupling agent”.

In a preferred embodiment of the present invention, the agents selected for the polyester masterbatch are a branching agent in conjunction with a coupling agent. In this case, the branching agent is preferably a polyol and the coupling agent is preferably a dianhydride.

It is an important feature of the present invention that the branching and/or chain coupling agent is dispersed in a polymeric matrix of polyester. In particular, that the branching and/or chain coupling agent is melt mixed with the polyester to become dispersed within the polymeric matrix of the polyester. As discussed above, branching and/or chain coupling agents are renowned for reacting with polyesters during melt mixing. Under these circumstances, there are limitations as to the type and amount of branching and/or chain coupling agents that can be used in the preparation of the masterbatches. Surprisingly, it has been found that polyesters having a melt processing temperature of 250° C. or less can be melt mixed with particular branching and/or chain coupling agents without significant reaction occurring between the branching and/or chain coupling agent and the polyester. Without wishing to be limited by theory, combinations of branching and/or chain coupling agents and polyesters that demonstrate low reactivity toward each other during melt mixing are believed to be those where the agent has a higher melting temperature than the melt processing temperature of the polyester, and/or where the agent has a poor solubility in the molten polyester.

In particular when the branching agent is a polyol, it is an important feature of the present invention that the polyol is melt mixed with the polyester to become dispersed within the polymeric matrix of the polyester. As discussed above, polyol compounds are renowned for reacting with polyesters during melt mixing. Under these circumstances, it is not possible to disperse polyol within the polymeric matrix as the polyol reacts with the polyester to become an integral part thereof. Surprisingly, it has been found that particular combinations of polyesters, with melt processing temperatures below 250° C., and polyol branching agents can be melt mixed without significant reaction between the polyester and the polyol occurring.

As will be appreciated from the discussion directly above, the lack of reactivity between the branching and/or chain coupling agent and the polyester is important. However, it is to be understood that this does not exclude the possibility of there being at least some reactivity of the agent toward the polyester. In particular, provided that there is no significant reaction between the agent and the polyester during melt mixing, it will be possible to prepare a useful masterbatch with branching and/or chain coupling agent dispersed within a polymeric matrix of polyester.

Preferably, no more than about 50 weight percent, more preferably no more than about 20 weight percent, still more preferably no more than about 10 weight percent, most preferably no more than about 5 weight percent of the polyester reacts with the branching and/or chain coupling agent during preparation of the masterbatch by melt mixing. In a particularly preferred embodiment of the present invention, substantially none of the polyester reacts with the branching and/or chain coupling agent during preparation of the masterbatch by melt mixing.

By the phrase “the polyester reacts with the branching and/or chain coupling agent” is meant that polyester chain end groups and/or internal moieties within the polyester chain react with the branching and/or chain coupling agent.

The degree of reaction that may occur between the branching and/or chain coupling agent and the polyester during preparation of the masterbatch can typically be assessed by a number of convenient and simple techniques. The simplest technique is to measure the melt flow index (MFI) of the masterbatch. Significant reaction of a branching agent such as pentaerythritol with the polyester will be evidenced by an increase in the polyesters MFI, whereas significant reaction of a branching/chain coupling agent such as pyromellitic dianhydride (PMDA) will be evidenced by a decrease in the polyesters MFI. The same can be detected by measuring the Intrinsic Viscosity of the carrier polyester.

The composition of the masterbatch may also be analyzed using techniques such as NMR and IR spectroscopy, where end group determination can be usefully applied. Alternatively, depending upon the choice of branching and/or chain coupling agent and polyester, the masterbatch could be extracted using an appropriate solvent to selectively isolate unreacted agent. Mass balance calculations could then be used to establish the degree of reactivity.

Reaction of the branching and/or chain coupling agent with the polyester will typically cause chain scission or chain coupling of the polyester chains, this in turn will be reflected in a reduction or increase, respectively, in the polyesters melt viscosity and/or the polyesters intrinsic viscosity (IV). For example reaction of the polyol with the polyester will typically cause chain scission of the polyester chains, this in turn will be reflected in a reduction of the polyesters melt viscosity and/or the polyesters intrinsic viscosity (IV).

The viscosity of the polyester melt during melt mixing can be readily assessed by measuring the force required to drive the mixing elements of the melt mixing device. In the case where the viscosity of the melt is reduced, the force required to drive the mixing elements will also generally be reduced, and where the viscosity of the melt is increased, the force required will also generally be increased. Where an extruder is used, this force can conveniently be determined by measuring the motor drive torque of the extruder. A reduction or increase in the IV of the polyester can be conveniently measured using techniques well known in the art.

A particular advantage provided by the masterbatch of the present invention is that it can be prepared using a diverse range of branching and/or chain coupling agents at both high and low concentrations without significant change in the rheological properties of the carrier polyester occurring. This advantage is particularly evident where a polyol branching agent is employed, or where low levels (from about 1 to about 5 weight percent) of a branching/chain coupling agent such as pyromelletic dianhydride are employed.

It will be appreciated by those skilled in the art the addition of some additives to a molten polymer may cause the melt viscosity of the polymer/additive mixture to increase or decrease simply through an additive being present in the melt, and not through any reaction of the additives with the polymer. Accordingly, such an increase or decrease in melt viscosity of the polymer/additive mixture should not be considered as an increase or decrease in the polymers melt viscosity per se.

Preferably, the polyesters melt viscosity and/or the polyesters intrinsic viscosity is reduced or increased by no more than 30%, more preferably no more than 15%, more preferably no more than 5% when it is melt mixed with the branching and/or chain coupling agent. In a particularly preferred embodiment, the melt viscosity and/or the intrinsic viscosity of the polyester remains substantially unchanged when it is melt mixed with the branching and/or chain coupling agent.

By virtue of there being no significant reaction between the branching and/or chain coupling agent and the polyester during melt mixing, the resulting masterbatch can be readily extruded and generally will have adequate physical and mechanical properties to function as a masterbatch. In particular, the molecular weight of the polyester is not reduced or increased during preparation of the masterbatch to a point where extrusion becomes impractical and/or difficult.

As discussed above, the relative melt temperatures of the branching and/or chain coupling agent and the polyester, and/or the solubility of the agent in the molten polyester are believed to be important parameters that influence the reactivity of the agent toward the polyester. Depending upon the particular combination of agent and polyester, any one of these parameters may influence the reactivity, or altemauvely both parameters may collectively influence the reactivity.

Preferably, the branching and/or chain coupling agent has a melt temperature which is at least 10° C. higher, more preferably at least 20° C. higher, still more preferably at least 40° C. higher than the melt processing temperature of the polyester.

Preferably, branching and/or chain coupling agent is present as a separate phase in the molten polyester during melt mixing. In particular, it is preferred that at least 50 weight percent, more preferably at least 65 weight percent, most preferably at least 85 weight percent of the branching and/or chain coupling agent is present as a separate phase in the molten polyester during melt mixing. In a particularly preferred embodiment, substantially all of the branching and/or chain coupling agent is present as a separate phase in the molten polyester during melt mixing.

In the immediately preceding paragraph, reference to the “molten polyester during melt mixing” is intended to be a reference to the molten polyester at the melt processing temperature of that polyester.

The masterbatch of the present invention provides a means of distributing the branching and/or chain coupling agent uniformly in a base polyester. In order to ensure branching and/or chain extension occurs uniformly in the base polyester during melt mixing, it is important that the masterbatch rapidly melts to thereby rapidly disperse the agent throughout the molten base polyester. It is believed that the agent can be more efficiently dispersed throughout the base polyester when the melt processing temperature of the masterbatch carrier polyester is lower than that of the base polyester.

A common base polyester that may be modified using a masterbatch in accordance with the present invention is PET. Suitable polyesters for use as the carrier polyester in the masterbatch of the present invention have a melt processing temperature of 250° C. or less, which is advantageously lower than that of PET (typically about 260° C.). Utilizing such low melt processing temperature polyesters also provides a means of increasing the melt temperature difference between the carrier polyester and branching and/or chain coupling agents having melt temperatures greater or around 250° C., the effect of which is believed to reduce reactivity of the agent toward the carrier polyester during preparation of the masterbatch.

Preferably, a low melt processing temperature polyester suitable for use in the masterbatch will have a melt processing temperature ranging from 150° C. to 250° C., more preferably from about 170° C. to about 240° C., most preferably from about 180° C. to about 230° C.

In considering suitable low melt processing polyesters for use in accordance with the present invention, those skilled in the art will appreciate that there are numerous factors which influence the melting properties of polyesters. Factors that are believed to contribute to providing a low melting polyester include chain structure irregularity, non-linear connection of monomeric units, lack of interchain attraction, bulky side chains, flexibility in the internal bond structure and an odd number of carbon atoms in the repeat units. Many of these factors in effect inhibit the ability of the polyester to develop crystallinity, and therefore polyesters having a low percentage of crystallinity often also have a low melt processing temperature.

The degree of crystallinity can, for example, be measured by various techniques, known by those skilled in the art. For instance differential scanning calorimetry (DSC) detects the heat of fusion at the melt temperature, which is directly proportional to the degree of crystallinity. The density of the polyester is also linked to the degree of crystallinity: as lower the density as higher is the degree of crystallinity. Both methods need calibration tests. An absolute method of detecting the degree of crystallinity is, for example, wide angle X-ray scattering. Where a low crystalline polyester is used as a low melt processing temperature polyester, it preferably has a crystallinity of less than about 15%, more preferably of less than about 5%.

It is particularly preferred that such a low crystalline polyester has substantially no crystallinity and is amorphous.

Another important parameter of low melt processing polyesters is their glass transition temperature: Suitable polyesters show a glass transition temperature of about 70° C., more preferably about 110° C. and most preferably about 150° C. below the melting temperature of the branching agent or chain coupling agent.

Those skilled in the art will appreciate that the degree of crystallinity of a given polyester will very much depend upon the molecular structure of the polyester. In particular, the degree of crystallinity of a polyester can be altered by simply changing the amount and/or type and/or distribution of monomer units that make up the polyester chain. For example, if about 8 mole percent of the ethylene glycol repeat units in PET are replaced with 1,4-cydohexanedimethanol repeat units, or about 15 mole percent by di-ethylene glycol repeat units, the resulting modified polyester can be amorphous and has a low melt processing temperature. Similarly, if about 15 mole percent of the terephthalic acid repeat units in PET are replaced with isophthalic acid repeat units, the resulting modified polyester can also be amorphous and have a low melt processing temperature. Such concepts can also be combined into one polyester or by melt mixing at least 2 different polyesters. Accordingly, the choice of a particular modifying acid or diol can significantly affect the melt processing properties of the polyester.

As used herein, the terms “modifying acid” and “modifying diol” are meant to define compounds, which can form part of the acid and diol repeat units of a polyester, respectively, and which can modify a polyester to reduce its crystallinity or render the polyester amorphous.

Examples of modifying add components may include, but are not limited to, isophthalic acid, phthalic acid, 1,3-cyclohexanedicarboxylic acid, succinic acid, glutaric acid, adipic acid, sebacic acid, suberic acid, 1,12-dodecanedioic acid, and the like. In practice, it is often preferable to use a functional acid derivative thereof such as the dimethyl, diethyl, or dipropyl ester of the dicarboxylic acid. The anhydrides or acid halides of these acids also may be employed where practical. Preferred is isophthalic acid.

Examples of modifying diol components may include, but are not limited to, neopentyl glycol, 1,4-cyclohexanedimethanol, 1,2-propanediol, 1,3-propanediol, 1,4-butanediol, 1,6-hexanediol, 1,2-cyclohexanediol, 1,4-cyclohexanediol, 1,2-cyclohexanedimethanol, 1,3-cyclohexanedimethanol, Z,8-bis(hydroxymethyltricyclo-[5.2.1.0]-decane wherein Z represents 3, 4, or 5; 1,4-Bis(2-hydroxyethoxy)benzene and diols containing one or more oxygen atoms in the chain, e.g. diethylene glycol, triethylene glycol, dipropylene glycol, tripropylene glycol, and the like. In general, these diols contain 2 to 18, preferably 2 to 8 carbon atoms. Cycloalphatic diols can be employed in their cis or trans configuration or as mixtures of both forms. 1,4-cyclohexanedimethanol or di-ethylene glycol are the preferred modifying diols.

Other suitable low melt processing polyesters are based on polyaddition of lactones, for example poly-ε-caprolacton.

Preferred is a polyester masterbatch composition wherein the polyester suitable for use in the masterbatch is glycol modified poly(ethylene terephthalate) (PET-G), poly-ε-caprolactone, or a copolyester containing greater than about 15% isophthalic units.

Polyesters suitable for use in the masterbatch of the present invention generally have an intrinsic viscosity (IV) of about 0.4 dL/g to about 1.5 dL/g, but those having values of about 0.6 dL/g to about 1.0 dL/g are preferred. Intrinsic viscosity can be determined in a 60/40 (wt/wt) phenol/tetrachloroethane solution at a concentration of 0.5 grams per 100 ml at 25° C.

In a specific embodiment the polyester for use in the masterbatch, is characterized by a melt viscosity of less than 2000 Pa sec at a shear rate of 100 s⁻¹ measured at a temperature below the melting temperature(s) of the branching agent and/or chain coupling agent

Below the melting temperature of the branching agent and/or chain coupling agent means at least 10° C. and preferably at least 20° C. below said temperature.

The masterbatch in accordance with the present invention may comprise a branching agent. Preferred branching agents include, but are not limited to, polyols and polyfunctional acid an hydrides.

Suitable polyol branching agents for use in the masterbatch have a functionality of three or more, which will be understood to mean that they have at least three hydroxy groups per molecule. For example, glycerol has a functionality of three and pentaerythritol has a functionality of four. Examples of suitable polyol branching agents, or precursors thereto, indude, but are not limited to, trimethylolethane, pentaerythritol sorbitol, 1,1,4,4-tetrakis(hydroxymethyl)cyclohexane, and dipentaerythritol, tripentaerythritol etc. One or more polyol branching agent may be used in combination.

Preferred polyol branching agents, or derivatives thereof, include pentaerythritol, dipentaerythritol, tripentaerythritol, and trimethylolethane.

As indicated above, the polyol branching agent may be provided in the form of a precursor thereto, or derivative thereof. By “precursor thereto” or “derivative thereof” it is meant a compound that is converted to the polyol during preparation of the masterbatch by melt processing.

Where the masterbatch in accordance with the present invention comprises a polyol branching agent, the polyol is preferably present in an amount from about 0.3 to about 30 weight percent, more preferably from about 0.3 to about 20 weight percent, most preferably from about 1 to about 10 weight percent, relative to the polyester carrier polymer.

Suitable polyfunctional acid anhydrides fbr use in the masterbatch have a functionality of three or more, which will be understood to mean that the polyfunctional acid anhydrides have at least three acid groups or acid group residues per molecule. For example, trimellitic acid anhydride has a functionality of three and pyromellitic acid dianhydride has a functionality of four.

Examples of polyfunctional and anhydrides that can be used in the masterbatch of the present invention include aromatic acid anhydrides, cyclic aliphatic anhydrides, halogenated acid anhydrides, pyromellitic dianhydride, benzophenonetetracarboxylic acid dianhydride, cyclopentanetetracarboxylic dianhydride, diphenyl sulfone tetracarboxylic dianhydride, 5-(2,5-dioxotetrahydro-3-furanyl)-3-methyl-3-cyclohexene-1,2-dicarboxylic dianhydride, bis(3,4-dicarboxyphenyl)ether dianhydride, bis(3,4-dicarboxyphenyl)thioether dianhydride, bisphenol-A bisether dianhydride, 2,2-bis(3,4-dicarboxyphenyl)hexafluoropropane dianhydride, 2,3,6,7-napthalenetetracarboxylic acid dianhydride, bis(3,4-dicarboxyphenyl)sulfone dianhydride, 1,2,5,6-napthalenetetracarboxylic acid dianhydride, 2,2′,3,3′-biphenyltetracarboxylic acid, hydroquinone bisether dianhydride, 3,4,9,10-perylene tetracarboxylic acid dianhydride, 1,2,3,4-cyclobutanetetracarboxylic acid dianhydride, 3,4-dicarboxy-1,2,3,4-tetrahydro-1-naphthalene-succinic acid dianhydride, bicyclo(2,2)oct-7-ene-2,3,5,6-tetracarboxylic acid dianhydride, tetrahydrofuran-2,3,4,5-tetracarboxylic acid dianhydride, 2,2-bis(3,4-dicarboxyphenyl)propane dianhydride, 3,3′,4,4′-biphenyltetracarboxylic acid dianhydride, 4,4′-oxydiphthalic dianhydride (ODPA), and ethylenediamine tetraacetic acid dianhydride (EDTAh). It is also possible to use acid anhydride containing polymers or copolymers as the anhydride component. Two or more polyfunctional acid anhydrides may be used in combination.

Preferred polyfunctional acid anhydrides, indude pyromellitic dianhydride, 1,2,3,4-cyclopentanetetracarboxylic acid dianhydride, 1,2,3,4-cyclobutanetetracarboxylic acid dianhydride and tetrahydrofuran-2,3,4,5-tetracarboxylic acid dianhydride. Most preferably the polyfunctional acid anhydride is pyromellitic dianhydride.

As indicated above, the polyfunctional acid anhydride may contain acid groups or acid group residues. By “acid group residue” is meant a residue of a carboxylic acid that has condensed with a second carboxylic acid to form an anhydride. In this case, the anhydride formed would contain two acid group residues.

Where the masterbatch in accordance with the present invention comprises a branching agent other than a polyol branching agent, the branching agent is preferably present in an amount from about 1 to about 60 weight percent, more preferably from about 5 to about 40 weight percent, most preferably from about 5 to about 30 weight percent, relative to the polyester carrier polymer.

The masterbatch in accordance with the present invention may comprise a chain coupling agent. Chain coupling agents that may be used with the present invention indude, but are not limited to, polyfunctional acid anhydrides, epoxy compounds, oxazoline derivatives, oxazolinone derivatives, lactams and related species. For examples of additional chain coupling agents we refer to Inata and Matsumura, J. App. Pol. Sci., 303325 (1988) and Lootqens et al J. App. Pol. Sci 65 1813 (1997) and Brown in “Reactive Extrusion” Ed Xanthos, Hanger, N.Y. 1992 p 75.

Those containing anhydride or lactam units are preferred for reaction with alcohol functionality of a base polyester when the masterbatch is subsequently used. Those containing oxazoline, oxazolinone, epoxide, carbodiimide units are preferred for reaction with acid functionality of a base polyester when the masterbatch is subsequently used.

Preferred chain coupling agents which may be used alone or in combination include the following:

(1) Polyepoxides such as bisphenole-A-diglycidylether, ebis(3,4-epoxycycohexylmethyl) adipate; N,N-diglycidyl bemzamide (and related diepoxies); N,N-diglycidyl aniline and derivatives; N,N-diglycidylhydantoin, uracil, barbituric acid or isocyanuric acid derivatives; N,N-diglycidyl diimides; N,N-diglycidyl imidazolones; epoxy novolaks; phenyl glycidyl ether; diethyleneglycol diglycidyl ether; Epikote 815 (diglycidyl ether of bisphenol A-epichlorohydrin oligomer).

(2) Polyoxazolines/Polyoxazolones such as 2,2-bis(2-oxazoline); 1,3-phenylene bis (2-oxazoline-2), 1,2-bis(2-oxazolinyl-2)ethane; 2-phenyl-1,3-oxazoline; 2,2′-bis(5,6-dihydro-4H-1,3-oxazoline); N,N′-hexamethylenebis (carbamoyl-2-oxazoline; bis[5(4H)-oxazolone); bis(4H-3,1 benzoxazin-4-one); 2,2′-bis(H-3,1-benzozin-4-one);

(3) Polyisocyanates such as 4,4′-methylenebis(phenyl isocyanate) (MDI); toluene diisocyanate, isocyanate terminated polyurethanes; isocyanate terminated polymers;

(4) Anhydrides

Examples of polyfunctional acid anhydrides are as previously defined for the branching agents.

(5) Polyacyllactams such as N,N′-terephthaloylbis(carpolactam) and N,N′-terephthaloylbis-(laurolactam). The use of these and similar compounds for PET chain extension has been disclosed by Akkapeddi and Gervasi in U.S. Pat. No. 4,857,603.

(6) Phosphorous (III) coupling agents such as triphenyl phosphite (Jaques et al Polymer 38 5367 (1997)) and other compounds such as those disclosed by Aharoni in U.S. Pat. No. 5,326,830. Where the masterbatch in accordance with the present invention comprises a chain coupling agent, the chain coupling agent is preferably present in an amount of from about 1 to about 60 weight percent, more preferably from about 5 to about 40 weight percent, more preferably from about 5 to about 30 weight percent, relative to the polyester carrier.

In a further embodiment of the invention the masterbatch composition may comprise additionally a phosphite, a phospinate or a phosphonate compound.

Phosphonates are in general preferred.

Preferably the phosphonate is of formula II 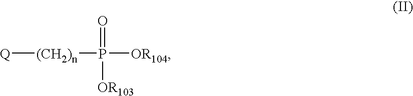
wherein

R₁₀₃ is H, C₁-C₂₀alkyl, unsubstituted or C₁-C₄alkyl-substituted phenyl or naphthyl,

R₁₀₄ is hydrogen, C₁-C₂₀alkyl, unsubstituted or C₁-C₄alkyl-substituted phenyl or naphthyl; or

M^{r+}/r,

M^{r+} is an r-valent metal cation or the ammonium ion,

n is 0, 1, 2, 3, 4, 5 or 6, and

r is 1, 2, 3 or 4;

Q is hydrogen, —X—C(O)—OR₁₀₇, or a radical

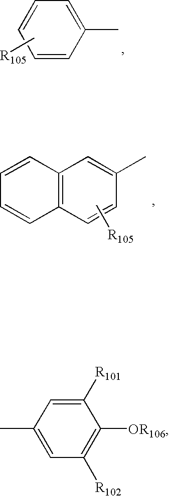

R₁₀₁ is isopropyl, tert-butyl, cydohexyl, or cyclohexyl which is substituted by 1-3 C₁-C₄alkyl groups,

R₁₀₂ is hydrogen, C₁-C₄alkyl, cyclohexyl, or cyclohexyl which is substituted by 1-3 C₁-C₄alkyl groups,

R₁₀₅ is H, C₁-C₁₈alkyl, OH, halogen or C₃-C₇cycloalkyl;

R₁₀₆ is H, methyl, trimethylsilyl, benzyl, phenyl, sulfonyl or C₁-C₁₈alkyl;

R₁₀₇ is H, C₁-C₁₀alkyl or C₃-C₇cycloalkyl; and

X is phenylene, C₁-C₄alkyl group-substituted phenylene or cyclohexylene.

Other suitable phosphonates are listed below.

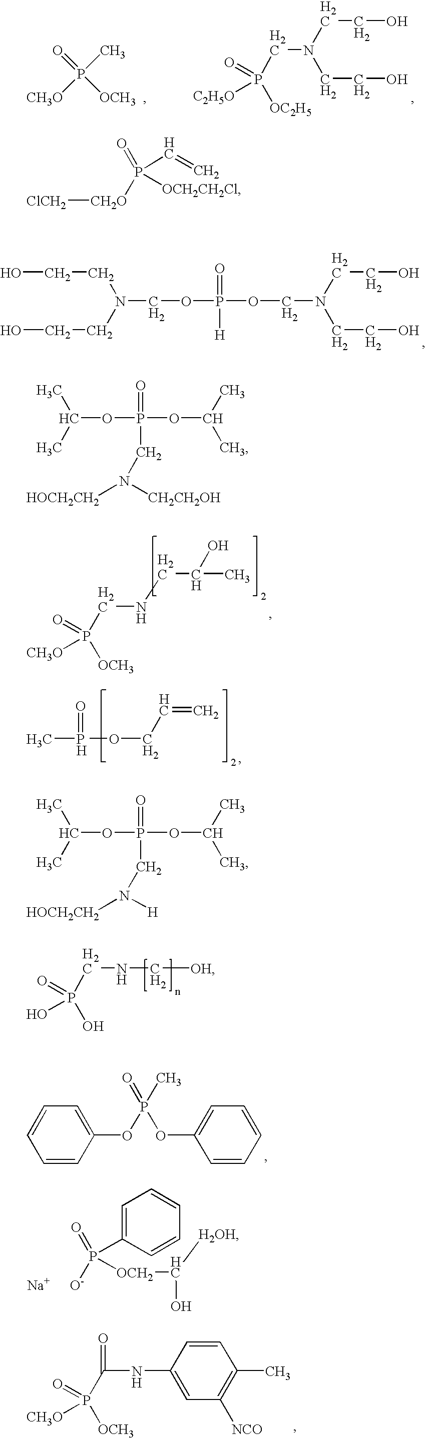

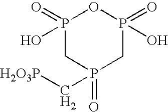

Sterically hindered hydmxyphenylalkylphosphonic acid esters or half-esters, such as those known from U.S. Pat. No. 4,778,840, are preferred.

Halogen is fluoro, chloro, bromo or iodo.

Alkyl substituents containing up to 18 carbon atoms are suitably radicals such as methyl, ethyl, propyl, butyl, pentyl, hexyl and octyl, stearyl and also corresponding branched isomers; C₂-C₄alkyl and isooctyl are preferred.

C₁-C₄Alkyl-substituted phenyl or naphthyl which preferably contain 1 to 3, more preferably 1 or 2, alkyl groups is e.g. o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl, 2,6-diethylphenyl, 1-methylnaphthyl, 2-methylnaphthyl, 4-methylnaphthyl, 1,6-dimethylnaphthyl or 4-tert-butylnaphthyl.

C₁-C₄Alkyl-substituted cyclohexyl which preferably contains 1 to 3, more preferably 1 or 2, branched or unbranched alkyl group radicals, is e.g. cyclopentyl, methylcyclopentyl, dimethylcyclopentyl, cyclohexyl, methylcyclohexyl, dimethylcyclohexyl, trimethylcyclohexyl or tert-butylcyclohexyl.

A mono-, di-, tri- or tetra-valent metal cation is preferably an alkali metal, alkaline earth metal, heavy metal or aluminium cation, for example Na⁺, K⁺, Mg⁺⁺, Ca⁺⁺, Ba⁺⁺, Zn⁺⁺, Al⁺⁺⁺, or Ti⁺⁺⁺⁺, Ca⁺⁺ is particularly preferred.

Preferred compounds of formula I are those containing at least one tert-butyl group as R₁ or R₂. Very particularly preferred compounds are those, wherein R₁ and R₂ are at the same time tert-butyl.

n is preferably 1 or 2 and, in particular 1.

For example the phosphonate is of formula IIa 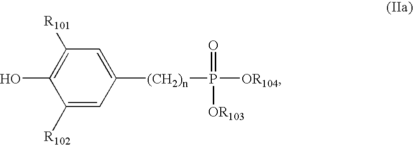
wherein

R₁₀₁ is H, isopropyl, tert-butyl, cyclohexyl, or cyclohexyl which is substituted by 1-3 C₁-C₄alkyl groups,

R₁₀₂ is hydrogen, C₁-C₄alkyl, cydohexyl, or cyclohexyl which is substituted by 1-3 C₁ -C₄alkyl groups,

R₁₀₃ is C₁-C₂₀alkyl, unsubstituted or C₁-C₄alkyl-substituted phenyl or naphthyl,

R₁₀₄ is hydrogen, C₁-C₂oalkyl, unsubstituted or C₁-C₄alkyl-substituted phenyl or naphthyl; or

M^{r+}/r;

M^{r+} is an r-valent metal cation, r is 1, 2, 3 or 4; and

n is 1, 2, 3, 4, 5 or 6.

Preferably the phosphonate is of formula III, IV, V, VI or VII 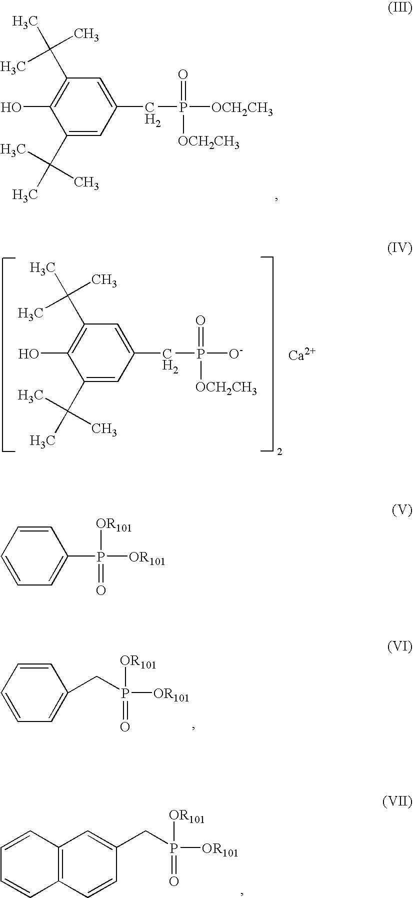
wherein the R₁₀₁ are each independently of one another hydrogen or M^{r+}/r.

Some of the compounds of formulas II, IIa, III, IV, V, VI, VII and VIII are commercially available or can be prepared by standard processes, as for example described in U.S. Pat. No. 4,778,840.

The phosphinates are of the formula XX 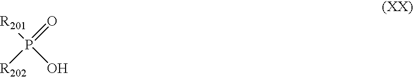
wherein
R₂₀₁ is hydrogen, C₁-C₂₀alkyl, phenyl or C₁-C₄alkyl substituted phenyl; biphenyl, naphthyl, —CH₂O-C₁-C₂₀alkyl or —CH₂—S-C₁-C₂₀alkyl,
R₂₀₂ is C₁-C₂₀alkyl, phenyl or C₁-C₄alkyl substituted phenyl; biphenyl, naphthyl, —CH₂—O-C₁-C₂₀alkyl or —CH₂S-C₁-C₂₀alkyl, or R₁ and R₂ together are a radical of the formula XXI 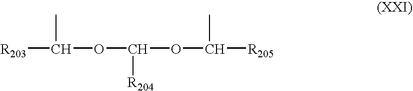
wherein
R₂₀₃, R₂₀₄ and R₂₀₅ independently of each other are C₁-C₂₀alkyl, phenyl or C₁-C₄alkyl substituted phenyl.

A specific phosphinate is for example compound 101

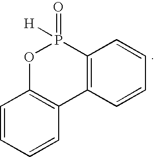

Typical phosphites useful in the instant invention are for example listed below.

For example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphde, diisodecyl pentaerythritol diphosphite, bis(2,4-di-tert-butylphenyl) pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butyl-phenyl)pentaerythritol diphosphite, tristearyl sorbitol triphosphite, 6-isooctyloxy-2,4,8,10-tetra-tert-butyl-12H-dibenz[d,g]-1,3,2-dioxaphosphocin, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyl-dibenz[d,g]-1,3,2-dioxaphosphocin, 2,2′,2″-nitriloftriethyltris(3,3′,5,5′-etra-ert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

Especially preferred are the following phosphites:

Tris(2,4-di-tert-butylphenyl) phosphite (Irgafos® 168, Ciba Specialty Chemicals), tris(nonyl-phenyl) phosphite,

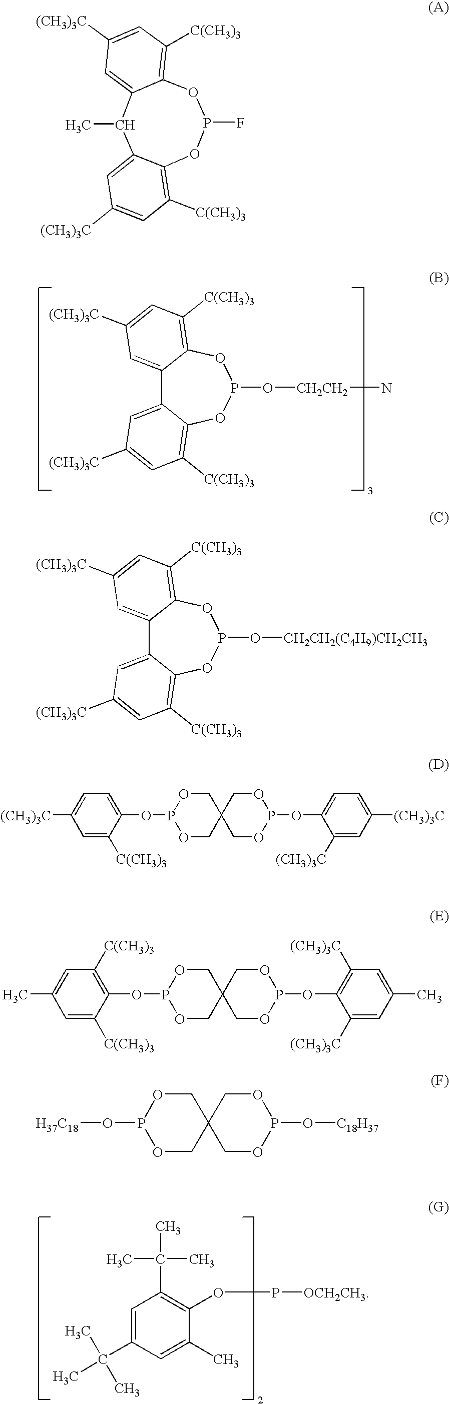

The masterbatch of the present invention is prepared by melt mixing a polyester with a branching and/or chain coupling agent. Melt mixing can be performed using methods well known in the art. Preferably, melt mixing is achieved by continuous extrusion equipment such as twin screw extruders, single screw extruders, other multiple screw extruders, such as Buss kneaders and Farell mixers. Preferably, melt mixing is performed so as to maintain the polyester at its melt processing temperature.

In preparing the masterbatch, one or more polyesters and one or more branching and/or chain coupling agents may be used.

Consequently in another aspect, the present invention provides a method of preparing a polyester masterbatch comprising melt mixing a polyester with a branching and/or chain coupling agent such that the branching and/or chain coupling agent is dispersed within the polymeric matrix of the polyester, wherein the polyester has a melt processing temperature of 250° C. or less.

A specific embodiment of the invention is a process for melt processing a base polyester comprising:
(1) formation of a molten mixture comprising
   (i) a major amount of a first resin composition comprising base polyester and from 0 up to about 1 weight % of the chain coupling agent and/or branching agent, and
   (ii) a minor amount of the above described polyester master batch composition comprising at least about 50 weight % polyester resin and greater than about 2 weight % of a chain coupling agent and/or branching agent,
   wherein the relative amounts of (i) and (ii) are such that said molten mixture comprises from about 0.1 wt % to about 1 wt % of said chain coupling agent and/or branching agent;
(2) melt processing of the resultant molten mixture under conditions of time and temperature sufficient to modify the base polyester; and
(3) direct fabrication of the molten mixture into a film, sheet, injection molded article, fiber or non-woven.

Suitable melt processing conditions are described above.

The term “direct fabrication” as used herein should be understood to mean that the molten mixture of base polymer and masterbatch is not first converted to powder or pellets for subsequent remelting in a later fabrication of desired articles, but is instead immediately melt fabricated into such article.

The definitions and preferences given above for the composition also apply for the process of manufacturing a polyester master batch.

The process of preparing the masterbatch can be performed in one or more processing steps.

Moreover, all the ingredients of the masterbatch can be mixed before and metered into an extruder, or metered separately.

Another option is the extrusion of one part of the masterbatch, and adding the other parts of the masterbatch later in the process. For example, the carrier polyester is metered into the extruder right from the beginning, and the active ingredients are metered in higher extrusion zones.

The masterbatch can be supplemented to a solid-state polycondensation for increasing the molecular weight of the carrier polyester. This is useful for adjusting the molecular weight of the polyester within the masterbatch to the molecular weight of the base polyester to be modified.

The masterbatches of the present invention may be used to modify a base polyester by melt mixing the base polyester with the masterbatch. A single masterbatch or a combination of masterbatches may be used. By this method, the polyester is modified through reaction with the branching agent to introduce branching within, or chain extend, the polyester chain structure. Typically, the base polyester will have a higher melt processing temperature than the masterbatch carrier polyester. Accordingly, at these higher temperatures the branching and/or chain coupling agent will have a greater tendency to react with the base polyester to chain extend it, and/or introduce branching points.

If desired, the modified polyester can be subjected to further processing, such as a solid state condensation process, to increase its molecular weight. Altematively, where a chain coupling agent has not been used, the modified polyester may be subsequently melt mixed with a chain coupling agent to increase its molecular weight. Preferably, the base polyester is melt mixed with a masterbatch comprising a chain coupling agent.

High melt strength polyesters may be obtained by melt mixing a base polyester with a polyol branching agent and a polyfunctional acid anhydride. In one preferred embodiment of the present invention a base polyester is modified using a combination of masterbatches prepared in accordance with the present invention comprising a polyol branching agent and a polyfunctional acid anhydride, respectively.

In another preferred embodiment of the invention, the masterbatch comprises a combination of a polyol branching agent and a polyfunctional acid anhydride. By combining these two agents in the masterbatch, the need for two separate masterbatches is conveniently avoided. It is believed that by selecting the carrier polyester, the polyol and the anhydride in accordance with the present invention, the masterbatch may be prepared without significant reaction between the carrier polyester, the polyol and the anhydride occurring. Accordingly, such a masterbatch advantageously comprises both a polyol branching agent and a polyfunctional acid anhydride dispersed within a polymeric matrix of polyester.

Other chain coupling agents may also be combined with a polyol branching agent in a masterbatch according to the present invention.

Where a masterbatch comprising a combination of branching and/or chain coupling agents is prepared, it may be that the branching and/or chain coupling agents react with each other to some extent during melt mixing. In this case, the resulting reaction product(s) may also be a branching and/or chain coupling agent(s) in its own right and therefore be a suitable agent(s) to act as a branching and/or chain coupling agent in accordance with the present invention.

In a further aspect, the present invention provides a method for modifying a polyester comprising melt mixing the polyester at a temperature above 250° C. together with a polyester masterbatch as described above.

Polyesters that can be modified by the method of the present invention are preferably thermoplastic polyesters and include all heterochain macromolecular compounds that possess repeat carboxylate ester groups in the backbone of the polymer. Also suitable for use as polyesters are polymers which contain esters on side chains or grafts, copolymers which incorporate monomers having carboxylate ester groups (in the backbone or as side groups or grafts) and derivatives of polyesters which retain the carboxylate ester groups (in the backbone or side groups or grafts). The polyesters may also contain acids, anhydrides and alcohols in the backbone or as side chains (eg acrylic and methacrylic containing polymers). Preferred polyesters include poly(ethylene terephthalate) (PET), poly(butylene terephthalate) (PBT), poly(ethylene naphthalate) (PEN), poly(tri-methylene terephthalate) (PTT), copolymers of PET, copolymers of PBT, copolymers of PEN, liquid crystalline polyesters (LCP) and polyesters of carbonic acid (polycarbonates) and blends of one or more thereof.

Copolymers of PET indude variants containing other comonomers. For example, the ethane diol may be replaced with other diols such as cyclohexane dimethanol to form a PET copolymer. Copolymers of PBT include variants containing other comonomers. Copolymers of PEN include variants containing other comonomers. Copolymers of PEN/PET are also useful in the present invention. These copolymers may be blended with other polyesters.

Liquid crystalline polyesters include poly(hydroxybenzoic acid) (HBA), poly(2-hydroxy-6-naphthoic acid) and poly(naphthalene terephthalate) (PNT) which is a copolymer of 2,6-dihydroxynaphthalene and terephthalic acid. Copolymers of liquid crystal polyesters with other polyesters are also suitable.

Side chain or graft ester, acid or alcohol containing polymers include: poly(methyl methacrylate) (or other methacrylates or acrylates); poly(methacrylic acid); poly(acrylic acid); poly(hydroxyethyl methacrylate), starch, cellulose etc.

Copolymers or graft copolymers containing acid, ester or alcohol groups indude ethylene co-vinyl acetate, ethylene co-vinyl alcohol, ethylene co-acrylic acid, maleic anhydride grafted polyethylene, polypropylene etc.

Where the masterbatch of the present invention comprises a polyol branching agent and a polyfunctional acid anhydride, it is preferred that the molar ratio of the polyfunctional acid anhydride to the polyol branching agent, or precursor thereto, is in the range of 0.5:1 to (10×C):1, where C is the number of moles of hydroxy groups per mole of polyol branching agent. It is particularly preferred that the molar ratio of polyfunctional acid anhydride to polyol, or precursor thereto, is in the range of from 2:1 to (2×C):1.

In order to clearly demonstrate the calculation of the molar ratio the following example is provided:

Example Calculation: Masterbatch composition comprising pyromellitic dianhydride (PMDA) and pentaerythritol.

PMDA=tetra functional anhydride

Pentaerythritol=tetra functional alcohol

The polyol, pentaerythritol, used in this example has a functionality of 4, therefore C=4.

The mole ratio of PMDA to pentaerythritol is therefore in the range of from 0.2:1 to 40 (10×4):1, with the preferred mole ratio of PMDA to pentaerythritol being in the range of from 2:1 to 8 (2×4):1. Accordingly, a masterbatch comprising 2.5 weight percent of pentaerythritol would comprise PMDA preferably in an amount ranging from about 8 weight percent to about 32 weight percent (ie in a mole ratio ranging from 2:1 to 8:1).

Where the masterbatch of the present invention only comprises one of a polyfunctional acid anhydride or a polyol branching agent, but the masterbatch is used to modify a base polyester where both a polyol and an anhydride are used, the molar ratio of polyol branching agent and polyfunctional acid anhydride is also preferably as previously defined.

The masterbatch in accordance with the present invention may comprise other additives such as fillers, pigments, stabilizers, blowing agents, nucleating agents etc. For examples of these and other suitable additional additives see U.S. Pat. No. 6,469,078.

The masterbatch may also comprise additives, such as heat stabilizers, light stabilizers, processing stabilizers, metal deactivators, nucleating agents and optical brighteners. Examples are given below.

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexyl phenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hyroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-5-tert-butyl-4-hydroxy-2-methylphenyl)-4-n-dodecylmercaptobutane, 1,1,5,5-tetra(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis([4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl4-hydroxybenzyl)-2,4,6-trimethylbenzene, 1,4-bis(3,5-di-tert-butylhydroxybenzyl)-2,3,5,6-tetramethylbenzene, 2,4,6-tris(3,5-di-tert-butylhydroxybenzyl)phenol.

1.10. Triazine compounds, for example 2,4-bis(octylmercapto)-6-(3,5-di-tert-butyl-4-hydroxyanilino 1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl-1,3,5-triazine, 1,3,5-tris(3,5-di-tert-butyl-4-hydroxyphenylpropionylyhexahydro-1,3,5-triazine, 1,3,5-tris(3,5-dicydohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3.5-di-tert-butyl-4-hydroxyphenyly)-propionic acid with mono- or polyhydric alcohols, e.g. with methanol, ethanol, n-octanol, 1-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyly)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenyl-amine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1,3′-dimethylbutyl)phenyl]amine, tert-octylated N-phenyl-1-naphthylamine, a mixture of mono- and dialkylated tert-butylutert-octyldiphenylamines, a mixture of mono- and dialkylated nonyidiphenylamines, a mixture of mono- and dialkylated dodecyidiphenylamines, a mixture of mono- and dialkylated isopropyl/isohexyldiphenylamines, a mixture of mono- and dialkylated tert-butyidiphenylamines, 2,3-dihydro-3,3-dimethyl-4H-1,4-benzothiazine, phenothiazine, a mixture of mono- and dialkylated tert-butyltert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV absorbers and light stabilisers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-3′-tert-butyl-2′-hydroxy-5′-methylphenyl-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyl-oxy)carbonylethyl]-2′-hydroxyphenyl-5-chlorobenzotriazole, 2-(3′-tert-butyl-2′-hydroxy-5′-(2-methoxycarbonylethyl)phenyl-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[242-othylhexyloxy)carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutylbenzotriazole-2-ylphenol]; the transesterification product of 2-[3-tert-butyl-5′-(2-methoxycarbonylethyl-2′-hydroxyphenyl]-2H-benzotriazole with polyethylene glycol 300; [R—CH₂CH₂—COO—CH₂CH₂—]₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]-benzotriazole; 2-[2′-hydroxy-3′-(1,1,3,3-tetramethylbutyl)5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl4-hydroxybenzoate, 2-methyl-4,6-di-tertbutylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyidiethanolamine, nickel dibutyidithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy4-methylphenylundecylketoxime, nickel complexes of 1-phenyll-4-auroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cydic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethylpiperidyl)nitrilotriacetate, tetrakis(2,2,6,6-tetramethyl-4-piperidylyl,2,3,4-butanetetracarboxylate, 1,1′-(1,2-ethanediylybis(3,3,5,5-tetramethylpiperazinone), 4-benzoyl-2,2,6,6-tetramethylpiperidine, 4-stearyloxy-2,2,6,6-tetramethyl-piperidine, bis(1,2,2,6,6-pentamethylpiperidyl)-2-n-butyl-2-(2-hydroxy-3,5-di-tert-butylbenyl)-malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl-1,3,5-triazine and 1,2-bis(3-aminopropylamino)-ethane, the condensate of 2-chloro-4,6-di-4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-pipendyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy4-(2,2,6,6-tetramethyl-4-piperidyl)]siloxane, a reaction product of maleic acid anhydride-aolefin copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxandide, N,N′-bis(3-dimethylaminopropyl)oxamide, 2-ethoxy-5-tert-butyl-2′-ethoxanilide and its mixture with 2-ethoxy-2′-ethyl-5,4′di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)4,6-bis(2,4-dimethylphenyl)-1,3,5-triazine, 2-(2-hydroxy-4-tridecyloxyphenyl)-4,6-bis(2,4-dimethylphenyl-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4,-(2)-hydroxy-3-octyloxypropyloxy)phenyl]-4,6-bis(2,4-dimethyl)-1,3,5-triazine, 2-[4-(dodecyloxy/tridecyloxy-2-hydroxypropoxyy-2-hydroxyphenyl]-4,6-bis(2,4-dimethylphenyly 1,3,5-triazine, 2-[2-hydroxy-4-(2-hydroxy-3-dodecyloxypropoxy)phenyl]-4,6-bis(2,4-dimethylphenyl)1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy-2-hydroxypropyloxy]phenyl}4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenyihydrazide, N,N′-diacetyladipoyl dihydrazide, N,N′-bis(salicyloyl)pxalyl dihydrazide, N,N′-bis(salicyloylthiopropionyl dihydrazide.

4. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N -hexadecyl-N-octadecylhydroxylamine, N-heptadecyl-N-octadecylhydroxylamine, N,N-dialkylhydroxylamine derived from hydrogenated tallow amine.

5. Nitrones, for example N-benzyl-alpha-phenyonitrone, N-ethyl-alpha-methyinitrone, N-octylalpha-heptyinitrone, N-lauryl-alpha-undecylnitrone, N-tetradecyl-alpha-tridecyinitrone, N-hexadecyl-alpha-pentadecylnitrone, N-actadecyl-alpha-heptadecyinitrone, N-hexadecyl-alpha-heptadecyinitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

6. Thiosynergists, for example dilauryl thiodipropionate or distearyl thiodipropionate.

7. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

8. Polyamide stabilisers, for example copper salts in combination with iodides and/or phosphorus compounds and salts of divalent manganese.

9. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

10. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyidibenzylidene)sorbitol, and 1,3:2,4-di(benzylidene)sorbitol.

11. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

12. Other additives, for example plasti cisers, lubricants, emulsifiers, pigments, rheology additives, catalysts, flow-control agents, optical brighteners, flameproofing agents, antistatic agents and blowing agents.

13. Benzofuranones and indolinones, for example those disclosed in U.S. Pat. No. 4,325,863; U.S. Pat. No. 4,338,244; U.S. Pat.No. 5,175,312; U.S. Pat. No. 5,216,052; U.S. Pat. No. 5,252,643; DE-A-4316611; DE-A-4316622; DE-A-4316876; EP-A0589839 or EP-A-0591102 or 3-[4-(2-acetoxyethoxy)-phenyl]-5,7di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl-5,7-di-tert-butylbenzofuran-2-one.

In a method of the present invention, a base polyester is modified by melt mixing the polyester with the masterbatch of the present invention. Condensation or transesterification catalysts may also be added to the melt mixing process in order to enhance the reaction rate of the polyol branching agent, and if present chain coupling agent, with the base polyester.

In a specific embodiment the masterbatch composition also includes a condensation or transesterificabon catalyst.

Typical transesterification or condensation catalysts include, but are not limited to, Lewis acids such as antimony trioxide, titanium oxide and dibutyltin dilaurate.

Other additives which may be incorporated with the masterbatch during melt mixing to modify the polyester include monofunctional additives to act as blockers so as to control the degree of chain extension and/or branching, as described by Edelman et al. in U.S. Pat. No. 4,1611,579, for the production of controlled branched polyesters by a combination of condensation/solid state polycondensation. Examples of suitable monofunctional additives include acids (eg. benzoic acid) or anhydrides or esters thereof (eg. benzoic acid anhydride, aoetic anhydride). Monofunctional alcohols may also be used.

Additives (eg. carbonates) may be incorporated to enhance foaming of the modified polyester where foamed products are required. Gases may also be injected into the molten polyester during melt mixing in order to achieve physical rather than chemical foaming.

In a method of the present invention a base polyester is modified by melt mixing it with the masterbatch of the present invention. Melt mixing may conveniently be achieved by continuous extrusion equipment such as twin screw extnuders, single screw extruders, other multiple screw extruders and Farell mixers. Semi-continuous or batch polymer processing equipment may also be used to achieve melt mixing. Suitable equipment includes injection moulders, Banbury mixers and batch mixers. Static mixing equipment may include pipes containing fixed obstacles arranged in such a way as to favour the subdivision and recombination of the flow to thoroughly mix the masterbatch, and any other additives or agents used, with the polyester.

The molecular structure of a modified polyester formed by the method of the present invention may exhibit a degree of branching. As discussed above, it may also be necessary to increase the molecular weight of the modified polyester to effect an increase in the polymers melt strength and melt viscosity. This can conveniently be achieved in a number of ways, for example the modified polyester may be subjected to a solid state condensation process, or a chain coupling agent may be used in the modification process itself.

Modified polyesters that exhibit improved melt strength may be advantageously used in blown film applications where higher melt viscosity, viscoelasticity and strength in the melt allow higher blow up ratios, greater biaxial orientation and faster through-puts while maintaining bubble stability.

The increased melt strength can be easily detected by an increase of the diameter of the polyester strand at the die of the extruder (i.e. die swell), compared to unmodified polyester. Further apparatus/parameters for characterizing the melt strength are: Goettfert Rheotens, uniaxial elongational viscosity and dynamic rheology.

The improved melt rheology of such modified polyester advantageously allows the reduction in processing steps and improvement in material properties. The improvements in melt rheology can allow the modified polyesters to be processed without prior drying, and facilitate the blow molding of polyesters. In particular, the improvements in the melt rheology facilitate stretch blow molding, facilitate the foaming of polyesters, enhance adhesion of the polyester to polar fillers such as those used in glass reinforced polyesters, and permit polyesters to be thermoformed with greater ease.

The use of the masterbatch composition according to the invention is beneficial within several plastic applications, for instance:
Beverage or cosmetic articles bottles
Film packaging for food or non-food
Sheets (e.g. thermoformable) for packaging (trays), construction or automotive applications
Injection molded articles
Belts or strappings
Profiles or pipes
Drums
Bottle crates
Textiles and non-wovens

The benefits caused by the instant masterbatch compositions are for example based on following effects:
Higher productivity according to adjusted melt rheology of the polyester (simpler processing)
Reaching technical feasibility of performing extrusion blow molding or extrusion blowing films with modified polyesters
Increasing molecular weight or/and melt strength without discoloration or gel formation
Increasing long-term thermal stability by initially higher molecular weight
Increasing mechanical properties (e.g. better tensile strength, higher elongation at break, higher burst pressure of bottles)
Improved impact properties (e.g. impact strength at ambient and temperature of −40° C., which is for example important for achieving better drop test result of frozen food articles in a tray)
Enhanced gas barrier (e.g. O₂, CO₂) by higher molecular weight and modified polymer chain structure
Superior thermal dimensional stability by higher molecular weight and modified polymer chain structure
processing polyester without pre-drying
compensating loss of molecular weight (I.V. loss) during melt processing
up-grading lower value PET grades during processing
recycling of degraded PET (post consumer or production waste)
pultrusion of PET-fibers
matching processing properties of C-PET (crystallizable)
replacing e.g. polycarbonate by modified polyesters

The masterbatches of the present invention may be preferably used in the following applications. Modification of bottle grade (IV˜0.80) or recycle PET to produce a polyester suitable for thernoforming. Modification of recycle PET to produce a polyester suitable for reforming into bottles. Modification of bottle or recycle PET to produce a polyester suitable for extrusion blow molding. Modification of bottle or recycle PET to produce a polyester suitable for foaming.

Consequently a further aspect of the invention is the use of a polyester masterbatch composition as described above for the modification of polyesters.

The present invention is further described with reference to the following non-limiting examples.

### EXAMPLES

Preparation of Masterbatches:

A) Masterbatches Comprising Pentaerythritol or Pyromellitic Dianhydride

Masterbatches were prepared using a Japanese Steel Works (JSW) TEX 30 twin screw extruded. The carrier polyester used was PETG (Eastar 6763). Prior to preparing the masterbatches, the PETG was dried in a dehumidifier dryer at 75° C. for 2.5 days. The polyol branching agent used was pentaerythritol, and pyromellitic dianhydride was used as a coupling/branching agent. Prior to preparing the masterbatches the pentaerythritol and pyromellitic dianhydride were dried in separate vacuum ovens at 150° C. for 3 days.

The PETG was melt mixed with a metered amount of the pentaerythritol or pyrqmellitic dianhydride and extruded in the form of a strand which was cooled under dry nitrogen then pelletized. The temperature of the barrels of the extruder were set at 170 (feed section), 180, 180, 180, 180, 180, 180, 180, 180, 180° C., with a 10 mm diameter rod die set at 180° C. The resulting masterbatches contained 5 weight percent, and 20 weight percent of pentaerythritol and pyromellitic dianhydride, respectively. For experimental data see Table 1.

B) Masterbatch Comprising Pentaerythritol and Pyromellitic Dianhydride and a Catalyst

A masterbatch was prepared using a Japanese Steel Works (JSW) TEX 30 twin screw extruded. The carrier polyester used was PETG (Eastar 6763). Prior to preparing the masterbatch, the PETG was dried for 50 hours at 85° C. in a nitrogen forced oven. The polyol branching agent used was pentaerythritol, and pyromelliuic dianhydride was used as a branching/chain coupling agent. A transesterification catalyst (antimony trioxide) was also included in the masterbatch. Prior to preparing the masterbatch, the pentaerythritol, pyromellitic dianhydride and the antimony trioxide were dried in a vaccum over overnight at 120° C. To assist in the introduction of the agents to the PETG during the melt mixing step, the agents were blended with a small amount of PET powder (BK2180, melt processing temperature of about 270° C.).

The PETG was melt mixed with a metered amount of aforementioned agents and extruded in the form of a strand which was cooled under dry nitrogen then pelletized. The temperature of the barrels of the extruder were set at 170 (feed section), 180, 180, 180, 180, 180, 180, 180, 180, 180° C., with a 10 mm diameter rod die set at 180° C. The resulting masterbatch contained 2.72 weight percent of pyromellitic dianhydride, 0.33 weight percent of pentaerythritol and 0.04 weight percent of antimony trioxide. For experimental data see Table 2.

In the following Tables CE#=comparative example, and EX#=example number #

TABLE 1
Preparation of the masterbatches EX-1 and EX-2

| | | | | | Melt | Melt | Drop Time | Temp | |
|---|---|---|---|---|---|---|---|---|---|
| Sample | PDMA | Pentaerythritol | PETG | Motors | Temperature | Pressure | from die | Die | |
| ID | Wt % | Wt % | Wt % | Amps | (° C.) (JSW) | (kg/cm2) | (seconds) | (° C.) | Comments |
| CE-1 | 0 | 0 | 100 | 19 | 232 | 2 | 16.7 | 232 | Clear |
| | | | | | | | | | Product |
| EX-1 | 20 | 0 | 80 | 18 | — | — | — | — | Hazy |
| | | | | | | | | | Product |
| EX-2 | 0 | 5 | 95 | 18 | — | — | — | — | Hazy |
| | | | | | | | | | Product |

TABLE 2
Preparation of the masterbatch EX-3

| | | | Antimony | | | | Melt | Melt | Drop Time | Temp | |
|---|---|---|---|---|---|---|---|---|---|---|---|
| Sample | PDMA | Pentaerythritol | Trioxide | BK2180 | PETG | Motor | Temperature | Pressure | from die | Die | |
| ID | Wt % | Wt % | wt % | Wt % | Wt % | Amps | (° C.) (JSW) | (kg/cm2) | (seconds) | (° C.) | Comments |
| CE-2 | 0 | 0 | 0 | 0 | 100 | 19 | 232 | 2 | 16.7 | 232 | Clear |
| | | | | | | | | | | | Product |
| EX-3 | 2.72 | 0.33 | 0.04 | 6.00 | 90.91 | 17 | 222 | 0 | 18.8 | 213 | Hazy |
| | | | | | | | | | | | Product |

Modification of a Base Polyester Using the Masterbatches Prepared in EX-1 to EX-3

A base polyester (BK3180, a bottle grade PET having a melt processing temperature of about 270° C. and an IV=0.82 dL/g) was modified using masterbatches prepared in EX-1 and Ex-2. Prior to modifying the base polyester, it was dried overnight in a dehumidifier drier at 130° C. The PETG masterbatches, Ex-1 and Ex-2, were dried for 48 hours at 85° C. under nitrogen.

The base polyester was melt mixed with a metered amount of a blend of masterbatches Ex-1 and Ex-2 to afford a concentration of the agents in the base polyester of 0.25 weight percent pyromellitic dianhydride, with an 8:1 molar ratio of pyromellitic dianhydride to pentaerythritol (i.e. 0.0194 weight percent of pentaerythritol). The temperature profile of the extruder was: 260° C., 280° C. (by 10), the die used was a 10 mm Brabender strand die. The extrudate exhibited a significant amount of die swell, indicating than an appreciable amount of chain branching/coupling has occurred. For experimental data see Table 3.

A base polyester (Shinpet 5015W, a bottle grade PET having a melt processing temperature of about 270° C. and an IV=0.75 dL/g) was modified using the masterbatch prepared in Ex-3. Prior to modifying the base polyester, it was dried overnight at 130° C. under nitrogen. The PETG masterbatch, EX-3 was dried for 48 hours at 85° C. under nitrogen.

The base polyester was melt mixed with a metered amount of masterbatch Ex-3 to afford a concentration of the agents in the base polyester of 0.27 weight percent pyromellitic dianhydride, 0.03 weight percent pentaerythritol and 0.004 weight percent of antimony trioxide. The temperature profile of the extruder was: 260° C., 280° C. (by 10), the die used was a 10 mm Brabender strand die. The extrudate exhibited a significant amount of die swell, indicating that an appreciable amount of chain branch/coupling has occurred. For example experimental data see Table 4.

TABLE 3
Modification of base polyester using masterbatches Ex-1 and Ex-2

| | | | | | | Melt | Melt | Drop Time | Temp | |
|---|---|---|---|---|---|---|---|---|---|---|
| Sample | EX-1 | EX-2 | BK3180 | Modifiers | Motor | Temperature | Pressure | from die | Die | |
| ID | Wt % | Wt % | Wt % | wt % | Amps | (° C.) (JSW) | (kg/cm2) | (seconds) | (° C.) | Comments |
| CE-3 | 0 | 0 | 100 | PDMA = 0 | 10 | 280 | 2 | 4 | 282 | Clear |
| | | | | Penta = 0 | | | | | | Product |
| EX-4 | 1.25 | 0.39 | 98.36 | PDMA = 0.25 | 22 | — | — | — | — | Clear |
| | | | | Penta = 0.0194 | | | | | | Product, |
| | | | | | | | | | | showing die |
| | | | | | | | | | | swell |

TABLE 4
Modification of base polyester using masterbatch Ex-3

| | | Shinpet | | | Melt | Melt | Drop Time | Temp | |
|---|---|---|---|---|---|---|---|---|---|
| Sample | EX-3 | 5015W | Modifiers | Motor | Temperature | Pressure | from die | Die | |
| ID | Wt % | Wt % | wt % | Amps | (° C.) (JSW) | (kg/cm2) | (seconds) | (° C.) | Comments |
| CE-4 | 0 | 100 | PDMA = 0 | 10 | 280 | 2 | 4 | 282 | Clear |
| | | | Penta = 0 | | | | | | Product |
| EX-5 | 10 | 90 | PDMA = 0.27 | 12 | 284 | 0 | 8 | 284 | Clear |
| | | | Penta = 0.03 | | | | | | Product, |
| | | | | | | | | | showing |
| | | | | | | | | | die swell |

Analysis of the Masterbatches Prepared in Ex-1 and Ex-2 by NMR Spectroscopy
Sample Preparation:

A sample of PETG (30 mg, Eastar 6763), as a control, was dissolved in CDCl₃ (0.5 mL), after dissolution the mixture was transferred to an NMR tube and an excess of trichloroacetyl isocyanate (10 μL, 6.3 mg, 3.36 mmol) was added. The ¹H NMR spectrum was recorded at room temperature on a Bruker DRX 500 operating at 500 MHz ¹H NMR (CDCl₃, ppm, δ): 8.05 (M, 99H, ArH), 8.50 (m, 0.30H, NH Alcohol), 8.65 (s. 0.08H, NH Alcohol), 10.36 (s, 1H, NH Acid).

A sample of masterbatch EX-1 (pyromellitic dianhydride) (30 mg) ws dissolved in CDCl₃ (0.5 mL), after dissolution the mixture was filtered and transferred to an NMR tube and an excess of trichloroacetyl isocyanate (10 μL, 6.3 mg, 3.36 mmol) was added. The ¹H NMR spectrum was recorded at room temperature on a Bruker DRX 500 operating at 500 MHz. ¹H NMR (CDCl₃, ppm, δ): 8.05 (m, 71H, ArH), 8.50 (m, 0.10H, NH Alcohol), 10.36 (s, 1H, NH Acid).

A sample of masterbatch EX-2 (pentaerythritol) (30 mg) was dissolved in CDCl₃ (0.5 mL), after dissolution the mixture was transferred to an NMR tube and an excess of trichloroacetyl isocyanate (10 μL, 6.3 mg, 3.36 mmol) was added. The ¹H NMR spectrum was recorded at room temperature on a Bruker DRX 500 operating a 500 MHz. ¹H NMR (CDCl₃, ppm, δ): 8.05 (m, 85H, ArH), 8.55 (m, 0.30H, NH Alcohol), 10.36 (s, 1H, NH Acid).

Results:

Addition of trichloroacetyl isocyanate (TAI) to a chloroform solution of PETG gives rise to a number of additional peaks in the ¹H NMR spectrum which occur at δ 10.36, 8.65 and 8.50 ppm. The signal at δ10.36 ppm has been assigned to the adduct resulting from the reaction between TAI and the acid end groups of PETG. The other two signals at δ8.65.

C) Preparation of Masterbatches Comprising Polyols or PMDA

The following examples show that both low melting (trimethylolpropane mp 60° C.) and high melting polyols (pentaerythritol mp 255° C.) may used to form PETG masterbatches when a low processing temperature (170° C.) is used.

Masterbatches were prepared using a Brabender single screw extruder (19 mm diameter screw with compression ratio˜3:1 and fdted with slotted mixing head) with, L/D=25:1, three heated zones and a 6 mm rod die. The low temperature profile had the three heated zones at 160° C., 170° C., 170° C. and die at 170° C. The high temperature profile had the three heated zones at 260° C., 270° C., 270° C. and die at 270° C. A nitrogen blanket was maintained over the feed throat.

Moisture levels were determined with a Arizona Instruments Computrac 3000 Moisture Analyzer on samples heated at 80° C.

The carrier polyester used was PETG (Eastar 6763). Prior to preparing the masterbatches, the PETG pellets were dried in a vacuum oven at 75° C. for 48 hrs (moisture level after drying was 55 ppm H₂O, melt flow index at 270° C. was 18.35 g/10 min). PETG powder was dried in vaccum oven at 75° C. for 3 hrs (moisture level after drying was 215 ppm H₂O, melt flow index at 200C was 1.13 g/10 min). Prior to preparing the masterbatches the PMDA and pentaerythritol were dried in a vacuum oven at 100° C. for 15 hours. Trimethylolpropane was used as received.

The PETG was mixed with a weighed amount of the polyol or PMDA and extruded in the form of a strand, which was cooled under dry nitrogen then pelletized. The temperature of the barrel of the extruder was set at as indicated in the Table 5-10. For experimental data see Tables 5-10.

TABLE 5
Formation of masterbatch at 170° C. with pentaeryithritol (Penta)

| | | | | pressure | throughput | Drop | MFI | Additive | Additive |
|---|---|---|---|---|---|---|---|---|---|
| Example | * C. | rpm | torq | psi | g/kg | Time | g/10 min | % | Used |
| control | 170 | 10 | 1315 | 93 | 369.6 | 147.56 | 1.3 | 0 | none |
| EX6 | 170 | 10 | 1213 | 91 | 299.9 | 181.02 | 1.2 | 0.3 | Penta |
| EX7 | 170 | 10 | 1130 | 92 | 314 | 209.85 | 1.35 | 1 | Penta |

TABLE 6
Attempted formation of masterbatch at 270° C. with pentaeryithritol (Penta)

| | | | | pressure | throughput | Drop | MFI | Additive | Additive |
|---|---|---|---|---|---|---|---|---|---|
| Example | * C. | rpm | torq | psi | g/kg | Time | g/10 min | % | Used |
| control | 270 | 10 | 0 | 0 | 246 | 14.41 | 3.63 | 0 | none |
| CE | 270 | 10 | 0 | 0 | 302.8 | 9.53 | 24.52 | 0.3 | Penta |
| CE | 270 | 10 | 0 | 0 | 304.8 | 4.16 | 43.89 | 1 | Penta |

TABLE 7
Formation of masterbatch at 170° C. with trimethylolpropane (TMP)

| | | | | pressure | throughput | Drop | MFI | Additive | Additive |
|---|---|---|---|---|---|---|---|---|---|
| Example | * C. | rpm | torq | psi | g/kg | Time | g/10 min | % | Used |
| control | 170 | 10 | 1315 | 93 | 369.6 | 147.56 | 1.3 | 0 | none |
| EX8 | 170 | 10 | 1618 | 63 | 431 | 148.25 | 1.88 | 0.3 | TMP |
| EX9 | 170 | 10 | 1029 | 43 | 287 | 181.25 | 1.77 | 1 | TMP |

TABLE 8
Attempted formation of masterbatch at 270° C. with trimethylolpropane (TMP)

| | | | | pressure | throughput | Drop | MFI | Additive | Additive |
|---|---|---|---|---|---|---|---|---|---|
| Example | * C. | rpm | torq | psi | g/kg | Time | g/10 min | % | Used |
| control | 270 | 10 | 0 | 0 | 248 | 14.41 | 3.63 | 0 | none |
| CE | 270 | 30 | 0 | 0 | 147.2 | 0.2 | 67.2 | 1 | TMP |

TABLE 9
Formation of masterbatch at 170° C. with PMDA

| | | | | pressure | throughput | Drop | MFI | Additive | Additive |
|---|---|---|---|---|---|---|---|---|---|
| Example | * C. | Rpm | Torq | psi | g/kg | Time | g/10 min | % | Used |
| control | 170 | 10 | 1315 | 93 | 369.6 | 147.56 | 1.3 | 0 | none |
| EX10 | 170 | 12 | 1369 | 78 | 389.4 | 159.37 | 1.22 | 0.3 | PMDA |
| EX11 | 170 | 12 | 1412 | 83 | 361.7 | 171 | 1.27 | 1 | PMDA |
| EX12 | 170 | 15 | 1576 | 94 | 395.1 | 173.11 | 1.65 | 10 | PMDA |

TABLE 10
Attempted formation of masterbatch at 270° C. with PMDA

| | | | | Pressure | Throughput | Drop | MFI | Additive | Additive |
|---|---|---|---|---|---|---|---|---|---|
| Example | * C. | Rpm | Torq | psi | g/kg | Time | g/10 min | % | Used |
| CE | 270 | 10 | 0 | 0 | 248 | 14.41 | 3.63 | 0 | none |
| CE | 270 | 10 | 0 | 0 | 255 | 15.72 | 2.76 | 0.30% | PMDA |
| CE | 270 | 10 | 0 | 3 | 191.3 | 19.03 | 2.21 | 0.30% | PMDA |
| CE | 270 | 10 | 0 | 6 | 155.9 | 22.81 | 1.81 | 1.00% | PMDA |

D) Preparation of Masterbatches Comprising Different Carrier Polyester and Additives.

Intrinsic Viscosity (I.V.):

1 g polymer is dissolved in 100 g of a mixture of phenolidi-chlorobenzene (1/1). The viscosity of this solution is measured at 30° C. in an Ubelode-viscosimeter and extrapolated to give the intrinsic viscosity.

Color

Color (b value of the Yellowness Index) is measured according to ASTM D1925 using a Hunter Lab Scan instrument

Melt Flow Rate (MFR):

MFR is determined with a Goettfert MP-P according to ISO 1133 at 260° C. with 2.16 kg weight after pre-drying the polyester.

Materials:

All carrier polyesters are dried prior to use (>12 h at 60° C. in vacuum)

Carrier Polyester A:

Polyester with following composition:

81.8 mol % p-terephthalic acid

18.2 mol % isophthalic acid

96.9% ethylene glycol

3.1% diethylene glycol

Commercial product of NanYa Plastics America Inc.

The polyester has a melt viscosity of 1315 Pa sec at a shear rate of 100 sec⁻¹ at 190° C., measured within Goettfert capillary rheometer “Rheograph 2001”; 10 mm capillary length, 1 mm capillary diameter.

Carrier Polyester B:

Polyester with following composition:

70.1 mol % p-terephthalic acid

29.9 mol % isophthalic acid

92.9% ethylene glycol

7.1% diethylene glycol

Commercial Product of NanYa Plastics America Inc.

The polyester shows a melt viscosity of 1035 Pa sec at a shear rate of 100 sec⁻¹ at 200° C., measured within Goettfert capillary rheometer “Rhograph 2001”; 10 mm capillary length, 1 mm capillary diameter.

Carrier Polyester C:

Poly-ε-caprolactone ex Fluka

The polyester shows a melt viscosity of 858 Pa sec at a shear rate 100/sec at 160° C. (measured within Goettfert capillary rheometer “Rheograph 2001”; 10 mm capillary length, 1 mm capillary diameter)

Chain Coupling Agents:

PMDA 1 ex Beyo (China) (powder) (melt temperature: 284° C.)

PMDA 2 ex Beyo (China) (coarse) (melt temperature: 287° C.)

Allinco® ex DSM (=dodecahydro-1,1′-carbonyl-bis azepin-2-one, CAS RN 19494-73-6)

Branching Agent:

Pentaerythrol ex Perstorp (Finland) (melt temperature: 262° C.) (=Penta)

Further Additives:

Irgamod 195 a phosphonate, commercial product of Ciba Specialty Chemicals,

Irganox 1222 a phosphonate, commercial product of Ciba Specialty Chemicals,

IRGAFOS 12 a phosphite, commercial product of Ciba Specialty Chemicals,

IRGAFOS 168 a phosphite, commercial product of Ciba Specialty Chemicals

IRGANOX HP136 a lactone, commercial product of Ciba Specialty Chemicals

Compound 101: synthesized by standard procedure

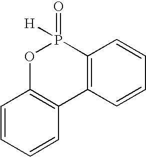

Compound 102: Di-isooctylphosphinic acid, purchased ex Fluka 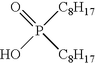
Base Polyester (To be Modified by Masterbatches):

All base polyesters are dried prior to use (>12 h at 80° C. in vacuum)

PET D: Polyclear T94 supplied by KoSa Gersthofen

PET E: Polyclear RT48 supplied by KoSa Gersthofen

PET F: Polydear RT21 supplied by KoSa Gersthofen

PET G1: ICI LaserPlus supplied by ICI

PBT X: Crastin SK605 NCO10 supplied by DuPont

### Examples MB1 to MB23

Producing masterbatch according to procedure A

General procedure A:

In a twin screw extruder (ZSK 25 from Werner & Pfleiderer) with screws rotating in the same direction, the below mentioned formulations are extruded at a temperature of Tₘₐₓ=180° C. (heating zone 1-6), a throughput of 5 kg/h, 100 rev/min and pelletized in a water bath.

The general procedure A is applied to following compositions:

| | Polyester | Chain coupling | Branching | | |
|---|---|---|---|---|---|
| Ex. No. | Carrier | agent | agent | Additive | |
| Comp A | 100% A | — | — | — | |
| Comp B | 95% A | — | — | 5% | Irgamod 195 |
| MB1 | 95% A | — | 5% Penta | — | |
| MB2 | 90% A | 10% PMDA 1 | — | — | |
| MB3 | 89% A | 10% PMDA 1 | 1% Penta | — | |
| MB4 | 88% A | 10% PMDA 1 | 2% Penta | — | |
| MB5 | 88% A | 10% PMDA 1 | 1% Penta | 1% | Irgamod 195 |
| MB6 | 89% B | 10% PMDA 1 | 1% Penta | — | |
| MB7 | 88% B | 10% PMDA 1 | 1% Penta | 1% | Irgamod 195 |
| MB8 | 88% B | 10% PMDA 1 | — | 2% | Irgamod 195 |
| MB9 | 75% B | 25% PMDA 1 | — | — | |
| MB10 | 72.5% B | 25% PMDA 1 | 2.5% Penta | — | |
| MB11 | 70% B | 25% PMDA 1 | 2.5% Penta | 2.5% | Irgamod 195 |
| MB12 | 70% B | 25% PMDA 1 | — | 5% | Irgamod 195 |
| MB13 | 89% C | 10% PMDA 1 | 1% Penta | — | |
| MB14 | 88% A | 10% PMDA 1 | 1% Penta | 1% | Irgafos 168 |
| MB15 | 88% A | 10% PMDA 1 | 1% Penta | 1% | Irgafos 12 |
| MB16 | 90% A | 10% Allinco | — | — | |
| MB17 | 89% A | 10% Allinco | — | 1% | Irgamod 195 |
| MB18 | 89% A | 10% Allinco | 1% Penta | — | |
| MB19 | 88% A | 10% Allinco | 1% Penta | 1% | Irgamod 195 |
| MB20 | 89% A | 10% PMDA 1 | 1% Penta | 1% | Irgafos HP136 |
| MB21 | 89% A | 10% PMDA 1 | 1% Penta | 1% | compound 101 |
| MB22 | 89% A | 10% PMDA 1 | 1% Penta | 1% | compound 102 |
| MB23 | 89.4% A | 10% PMDA 1 | 0.5% Penta | 0.1% | Sb₂O₃ |

### Examples MB24 to MB27

Producing masterbatch according to procedure B

General procedure B:

In a Buss co-kneader (MDK 140), with a separate transversal screw for extrusion into the die, the below mentioned formulations are extruded at body temperature of 210° C., kneader axe and die temperature of both 180° C., a throughput of 400 kg/h, 140 rev/min (kneader axe) and pelletized in a water bath.

The general procedure B is applied to following compositions:

| | Polyester | Chain coupling | Branching | |
|---|---|---|---|---|
| Ex. No. | Carrier | agent | agent | Additive |
| Comp C | 100% B | — | — | — |
| MB24 | 89% B | 10% PMDA 1 | 1% Penta | — |
| MB25 | 88% B | 10% PMDA 1 | 1% Penta | 1% Irgamod 195 |
| MB26 | 88% B | 10% PMDA 1 | — | 2% Irgamod 195 |
| MB27 | 76% B | 20% PMDA 2 | 2% Penta | 2% Irgamod 195 |

E) Modification of Base Polymer Using the Masterbatches:
General Procedure

In a twin screw extruder (ZSK 25 from Werner & Pfleiderer) with screws rotating in the same direction, the below mentioned formulations were extruded at a temperature of Tₘₐₓ=280° C. (heatng zone 1-6), a throughput of 6 kg/h and 100 rev/min and pelletized in a water bath.

The general procedure is applied to the following comparative examples.

| | | | MFR | | |
|---|---|---|---|---|---|
| | Base | | g/10 | I.V. | Color |
| Ex. No. | Polyester | Additives | min | dl/g | B*-value |
| Comp D | 100% E | — | 62 | 0.55 | 0.92 |
| Comp E | 100% E | 0.2% PMDA 1 | 25 | 0.66 | 9.2 |
| | | 0.02% Penta | | | |
| | | 0.02% Irgamod 195 | | | |
| Comp F | 100% F | — | 18 | 0.57 | — |
| Comp G | 100% G1 | — | 14 | 0.75 | — |
| Comp H | 100% D | — | 16 | 0.76 | — |

The general procedure is applied to the following examples C1-C25.

| | | | Equivalent to | MFR | I.V. | Color |
|---|---|---|---|---|---|---|
| Ex. No. | Polyester | Masterbatch | additive composition | g/10 min | dl/g | B*-value |
| Ex C1 | 100% E | 2% MB15 | 0.2% PMDA 1 | 21 | 0.69 | −1.3 |
| | | | 0.02% Penta | | | |
| | | | 0.02% Irgamod 195 | | | |

The performance of the masterbatch MB15 is much better (with regard to decrease of MFR, increase of I.V. and color) compared to the addition of the active ingredients directly (as tested in the comparative example Comp E).

| | Base | | | MFR | I.V. |
|---|---|---|---|---|---|
| Ex. No. | Polyester | Masterbatch | | G/10 min | dl/g |
| Ex C2 | 100% D | 1% | MB2 | 6.3 | 0.84 |
| Ex C3 | 100% D | 3% | MB2 + | 2.1 | 0.91 |
| | | 0.6% | MB1 | | |
| Ex C4 | 100% D | 1% | MB3 | 8.7 | 0.86 |
| Ex C5 | 100% D | 1% | MB3 + | 4.3 | 0.94 |
| | | 0.5% | Comp B | | |
| Ex C6 | 100% D | 1% | MB4 | 9.4 | 0.82 |
| Ex C7 | 100% D | 1% | MB5 | 8.3 | 0.86 |
| Ex C8 | 100% E | 3% | MB6 | 11 | 0.74 |
| Ex C9 | 100% E | 3% | MB7 | 14 | 0.72 |
| Ex C10 | 100% E | 3% | MB8 | 9.0 | 0.75 |
| Ex C11 | 100% G1 | 1% | MB9 | 7.4 | 0.80 |
| Ex C12 | 100% G1 | 1% | MB10 | 9.0 | 0.78 |
| Ex C13 | 100% G1 | 1% | MB11 | 8.6 | 0.81 |
| Ex C14 | 100% G1 | 1% | MB12 | 11 | 0.80 |
| Ex C15 | 100% E | 3% | MB13 | 10 | 0.73 |
| Ex C16 | 100% E | 3% | MB14 | 11 | 0.75 |
| Ex C17 | 100% E | 3% | MB15 | 9.8 | 0.75 |
| Ex C18 | 100% D | 3% | MB16 | 15 | 0.76 |
| Ex C19 | 100% D | 3% | MB17 | 14 | 0.81 |
| Ex C20 | 100% D | 3% | MB18 | 14 | 0.82 |
| Ex C21 | 100% D | 3% | MB19 | 13 | 0.83 |
| Ex C22 | 100% E | 2% | MB20 | 14 | 0.70 |
| Ex C23 | 100% E | 2% | MB21 | 15 | 0.71 |
| Ex C24 | 100% E | 2% | MB22 | 15 | 0.72 |
| Ex C25 | 100% E | 2% | MB23 | 16 | 0.70 |

F) Producing Extrusion-Blown Films

General procedure:

In a twin screw extruder (Haake TW100, counter-rotating conical screws), the below mentioned formulations are extruded at a temperature of Tₘₐₓ=280° C., a throughput of 1.8 kg/h and 60 rev/min into a film blowing die.

The general procedure is applied to comparative examples M and N and to the examples D1 and D2 according to the invention.

| | Base | | | Film | |
|---|---|---|---|---|---|
| Ex. No. | Polyester | Additives | | thickness | Remarks |
| Comp M | 100% D | — | | *** | |
| Comp N | 100% D | 0.3% | PMDA 1 | 25.3 μm | Yellow film |
| | | 0.03% | Penta | | Many gels |
| Ex D1 | 100% D | 3% | MB3 | 17.5 μm | No |
| | | | | | discoloration |
| | | | | | No gels |
| Ex D2 | 100% D | 3% | MB5 | 10.9 μm | No |
| | | | | | discoloration |
| | | | | | No gels |

*** extrusion blowing a film was not feasible due to too low melt strength

1. A polyester masterbatch composition comprising
a branching and/or a chain coupling agent dispersed within a polymeric matrix of polyester, wherein the polyester has a melt processing temperature of 250° C. or less.

2. A polyester masterbatch composition according to claim 1 wherein the agent is a chain branching agent.

3. A polyester masterbatch composition according to claim 2 wherein the chain branching agent is a polyol.

4. A polyester masterbatch composition according to claim 1 wherein the agent is a chain coupling agent.

5. A polyester masterbatch composition according to claim 4 wherein the chain coupling agent is a dianhydride.

6. A polyester masterbatch composition according to claim 1 wherein the agents are a chain branching agent and a chain coupling agent.

7. A polyester masterbatch composition according to claim 6 wherein the chain branching agent is a polyol and the chain coupling agent is a dianhydride.

8. A polyester masterbatch composition according to claim 1 wherein the polyester's melt viscosity and/or the polyester's intrinsic viscosity is reduced or increased by no more than 30% when it is melt mixed with the branching and/or chain coupling agent.

9. A polyester masterbatch composition according to claim 1 wherein the branching and/or chain coupling agent has a melt temperature which is at least 10° C. higher than the melt processing temperature of the polyester.

10. A polyester masterbatch composition according to claim 1 wherein the polyester suitable or use in the masterbatch has a melt processing temperature ranging from 150° C. to 250° C.

11. A polyester masterbatch composition according to claim 1 wherein the polyester suitable for use in the masterbatch has a crystallinity of less than 15%.

12. A polyester masterbatch composition according to claim 1 wherein the polyester suitable for use in the masterbatch is glycol modified poly(ethylene terephthalate) (PETG), poly-ε-caprolactone, or a copolyester containing greater than about 15% isophthalic units.

13. A polyester masterbatch composition according to claim 1 wherein the branching agent is a polyol, which is present in an amount of from 0.3 to 30 weight percent based on the weight of the polyester masterbatch polymer.

14. A polyester masterbatch composition according to claim 1 wherein the chain coupling agent is present in an amount of from 1 to 60 weight percent based on the weight of the polyester masterbatch polymer.

15. A polyester masterbatch composition according to claim 1, which additionally comprises a phosphite, a phospinate or a phosphonate compound.

16. A polyester masterbatch composition according to claim 15 wherein the phosphonate is of formula III, IV, V, VI or VII 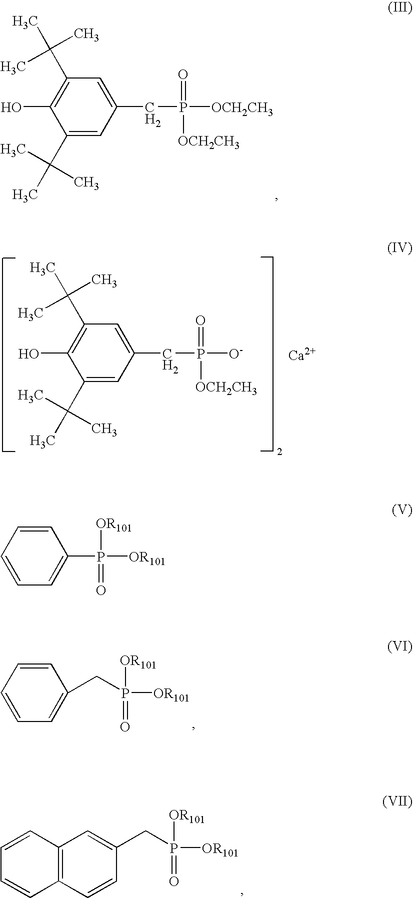
wherein the R₁₀₁ are each independently of one another hydrogen or M^{r+}/r.

17. A polyester masterbatch composition according to claim 1, which also includes a condensation or transesterification catalyst.

18. A method of preparing a polyester masterbatch comprising
melt mixing a polyester with a branching and/or chain coupling agent such that the branching and/or chain coupling agent is dispersed within the polymeric matrix of the polyester, wherein the polyester has a melt processing temperature of 250° C. or less.

19. A method for modifying a polyester comprising
melt mixing the polyester at a temperature above 250° C. together with a polyester masterbatch according to claim 1.

20. Use of a polyester masterbatch composition according to claim 1 for the modification of polyesters.
